(19) United States
(12) Patent Application Publication
(10) Pub. No.: US 2009/0211137 A1
(43) Pub. Date: Aug. 27, 2009

(54) Product Identification Device, System, And Method

(76) Inventors: Andy Trantham, Winston-Salem, NC (US); Chad Cheek, Kemersville, NC (US); Charllie Stack, Kernesville, NC (US); Matthew Waterman, Plafftown, NC (US)

Correspondence Address: KILPATRICK STOCKTON LLP, 1001 WEST FOURTH STREET, WINSTON-SALEM, NC, 27101, US

(21) Appl. No.: 12/366,872

(22) Filed: Feb. 6, 2009

Related U.S. Application Data
(60) Provisional application No. 61/027,534, filed on Feb. 11, 2008.

(51) Int. Cl. G09F 3/20

(52) U.S. Cl. 40/654.01

(57) ABSTRACT

A product identification device, system, and method can include an inner card slidable into and out of an outer sleeve, product identification information for a plurality of products arranged along an axis of the inner card, and product characteristics arranged along another axis of the inner card that are selectively associated with each of the plurality of products. The inner card can be slid relative to the outer sleeve to display the product identification information in a product identification window in the outer sleeve one product at a time. The product characteristics for the product displayed in the product identification window can be simultaneously displayed in a product characteristic window in the outer sleeve adjacent the product identification window.

### CROSS-REFERENCE TO RELATED APPLICATION

This application claims benefit of U.S. Provisional Patent App. No. 61/027,534, filed Feb. 11, 2008, which application is incorporated by reference herein in its entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to a product identification device, system, and method. Some embodiments of the present invention may be useful for identifying the colors in which a garment are available for purchase.

### BACKGROUND OF THE INVENTION

A category of products can be available to consumers having a variety of different characteristics. For example, a line of clothing such as shirts can be available in different fabrics, various styles of cuffs, collars, pockets, and buttons, a range of sizes, and different colors. Manufacturers often present the choice of garments to consumers and/or to retailers using materials that describe and represent each garment style, fabric, size, color, price, and/or other characteristics. Such materials can include written descriptions of each garment within a line of clothing having different characteristics, a photograph or other graphic depiction of each garment, a sample or swatch of the fabric in each garment, and/or other materials. Such marketing or product information materials can include manufacturer-specific information, for example, brand names, product category names, style numbers, etc. With the large variety of characteristics available in many lines of clothing or other consumer products, the materials needed to adequately represent the selections available to retailers and/or consumers can also be quite large.

Use of product information materials for each item within a product category can be expensive to provide and can be burdensome to a retailer or consumer to sort through. Thus, it may be desirable to provide product information that represents a variety of individual product characteristics in a more concise, less expensive, and easy to use manner.

### SUMMARY

Some embodiments of the present invention can include a product identification device, system, and/or method. In certain embodiments, the product identification device can include an outer sleeve having two sides, a bottom, and an open top, and an inner card slidable into and out of the outer sleeve through the open top. The device can further include product identification information for a plurality of products arranged along an x-axis toward a side of the inner card, and product characteristics arranged along a y-axis of the inner card and in selective association with each of the plurality of products. The device can further include a product identification window in the outer sleeve adapted to display the product identification information for one of the plurality of products at a time, and a product characteristic window in the outer sleeve adjacent the product identification window adapted to display the product characteristics for the product displayed in the product identification window.

In some embodiments, the present invention can comprise a product identification system that includes the product identification device described herein.

In some embodiments, the present invention can comprise a product identification method that includes utilizing the product identification device described herein. For example, one embodiment of such a method can include providing a product identification device comprising an outer sleeve having two sides, a bottom, and an open top, and an inner card slidable into and out of the outer sleeve through the open top. The method can further include arranging product identification information for a plurality of products along an x-axis toward a side of the inner card, and arranging product characteristics along a y-axis of the inner card and in selective association with each of the plurality of products. The product identification information can be displayed for one of the plurality of products at a time through a product identification window in the outer sleeve. The product characteristics for the product displayed in the product identification window can be displayed through a product characteristic window disposed in the outer sleeve adjacent the product identification window.

Features of a product identification device, system, and/or method may be accomplished singularly, or in combination, in one or more of the embodiments of the present invention. As will be realized by those of skill in the art, many different embodiments of a product identification device, system, and/or method are possible. Additional uses, advantages, and features of aspects of the present invention are set forth in the illustrative embodiments discussed in the detailed description herein and will become more apparent to those skilled in the art upon examination of the following.

### BRIEF DESCRIPTION OF THE DRAWINGS

FIG. 1 is a front view of a product identification device in an embodiment of the present invention.

FIG. 2 is a diagrammatic front view of the product identification device shown in FIG. 1, showing an inner card movable in and out of an outer sleeve in an embodiment of the present invention.

FIG. 3 is a rear view of the product identification device shown in FIG. 1, showing the various colors in which a product is available in an embodiment of the present invention.

FIG. 4 is a rear view of the product identification device as shown in FIG. 3, showing the inner card having product identification information and product characteristics identified and moved partially out of the outer sleeve in an embodiment of the present invention.

### DETAILED DESCRIPTION

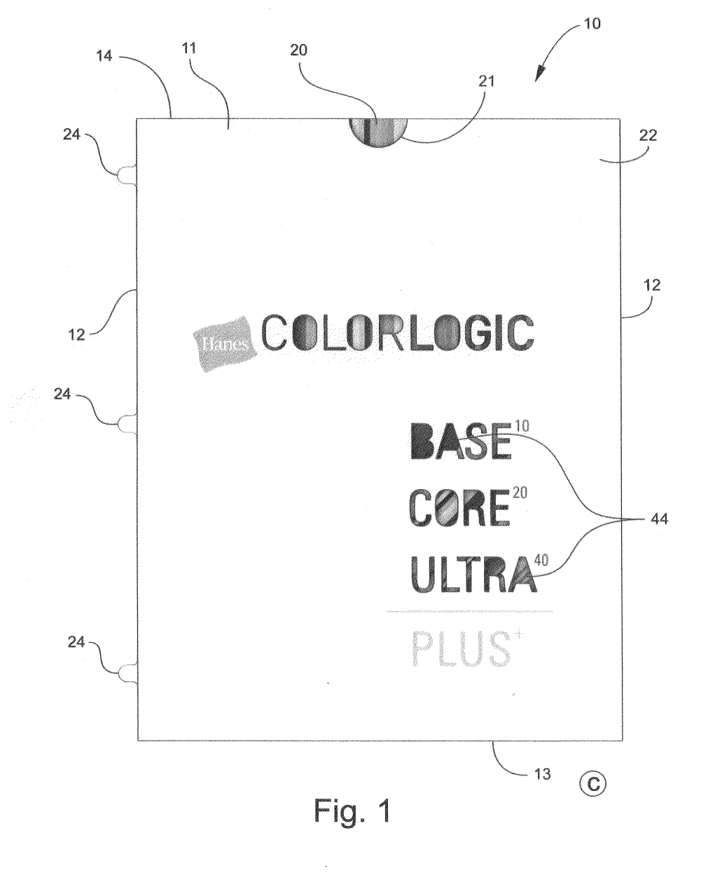

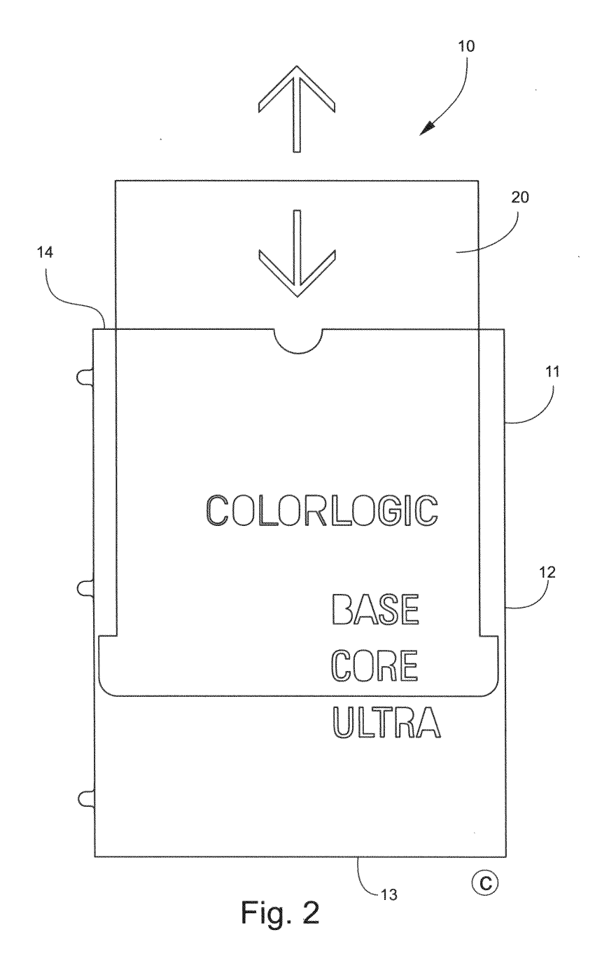

Some embodiments of the present invention provide a product identification device, system, and/or method. FIGS. 1-4 illustrate embodiments of such a product identification device, system, and method. As shown in FIGS. 1-4, the product identification device 10 can include an outer envelope, or sleeve 11, having two closed sides 12, a closed bottom 13, and an open top 14. The device 10 can further include an inner card 20 slidable within the outer sleeve 11 and into and out of the open top 14 of the sleeve 11.

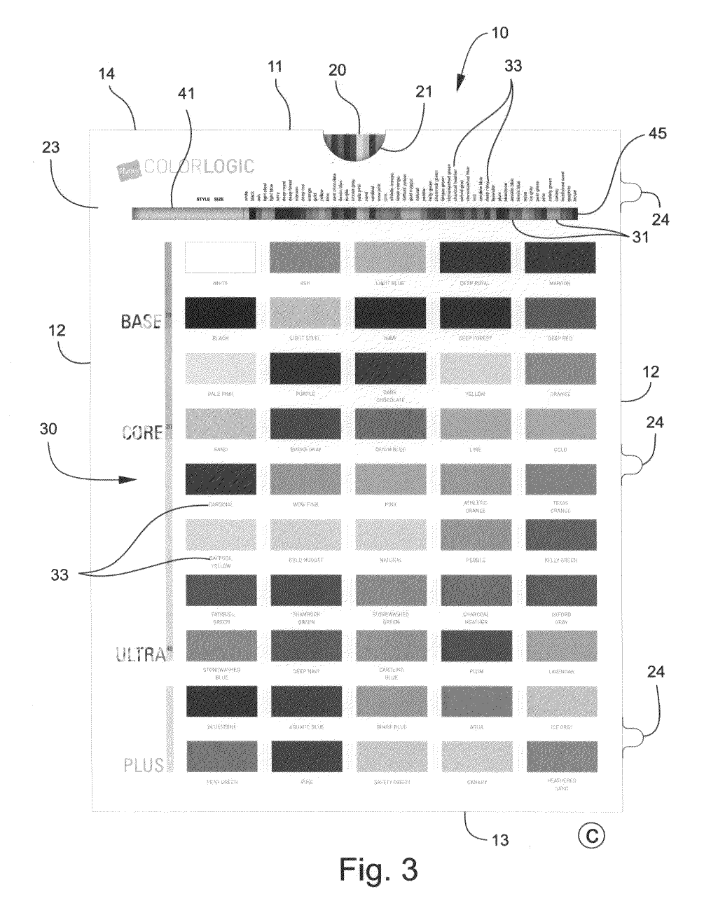

In some embodiments, the product identification device 10 can include a thumb notch 21 located at the top 14 of the sleeve 11 in at least one of the front side 22 and the back side 23 of the sleeve 11. As shown in FIGS. 1 and 3, the device 10 can include the thumb notch 21 in both the front and back sides 22, 23 of the sleeve 11. When fully inserted into the outer sleeve 11, the inner card 20 can extend above the bottom level of the thumb notch 21 so that the inner card 20 can be contacted with a person's thumb and/or finger(s), for example, between a person's thumb and finger, and moved upwardly out of the outer sleeve 11.

In some embodiments, the product identification device 10 can include one or more ringed tabs 24 extending outwardly along one or more sides 12 of the device 10. As shown in the embodiments in FIGS. 1-4, the device 10 can include three tabs 24 extending outwardly along one vertical side 12 of the sleeve 11. The tab(s) 24 may be useful for mounting the product identification device 10 in a binder, attaching the device 10 to other product identification materials, etc.

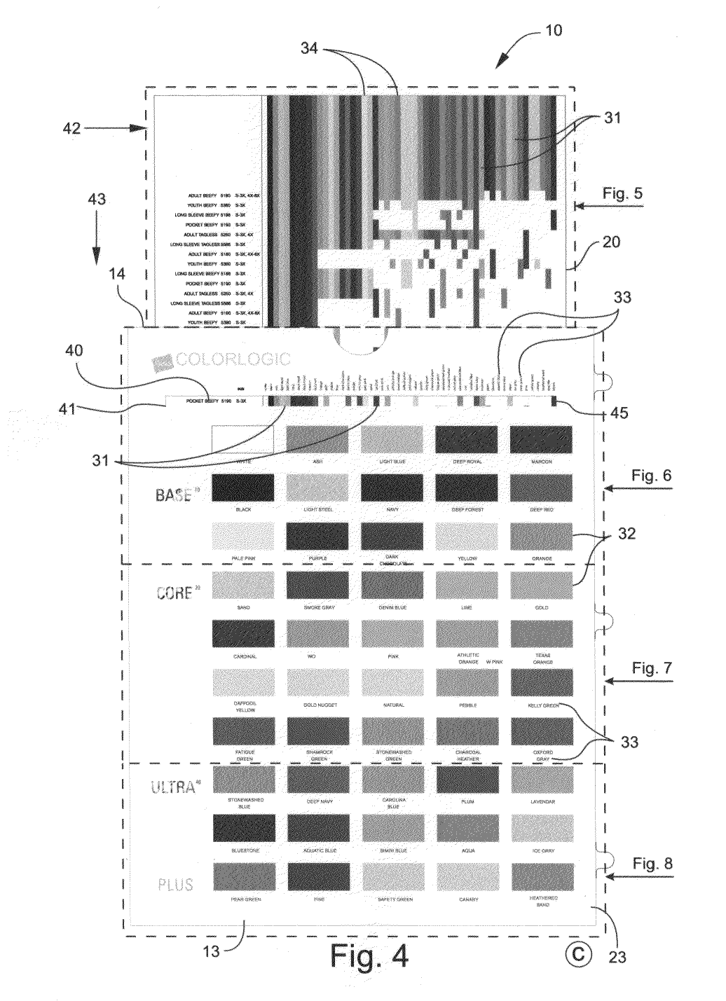

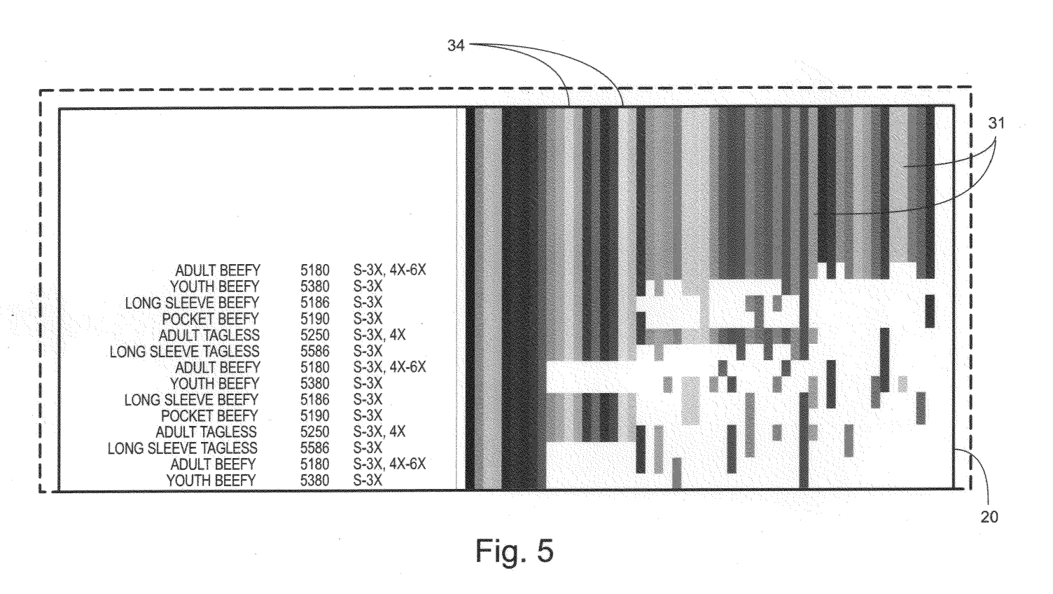

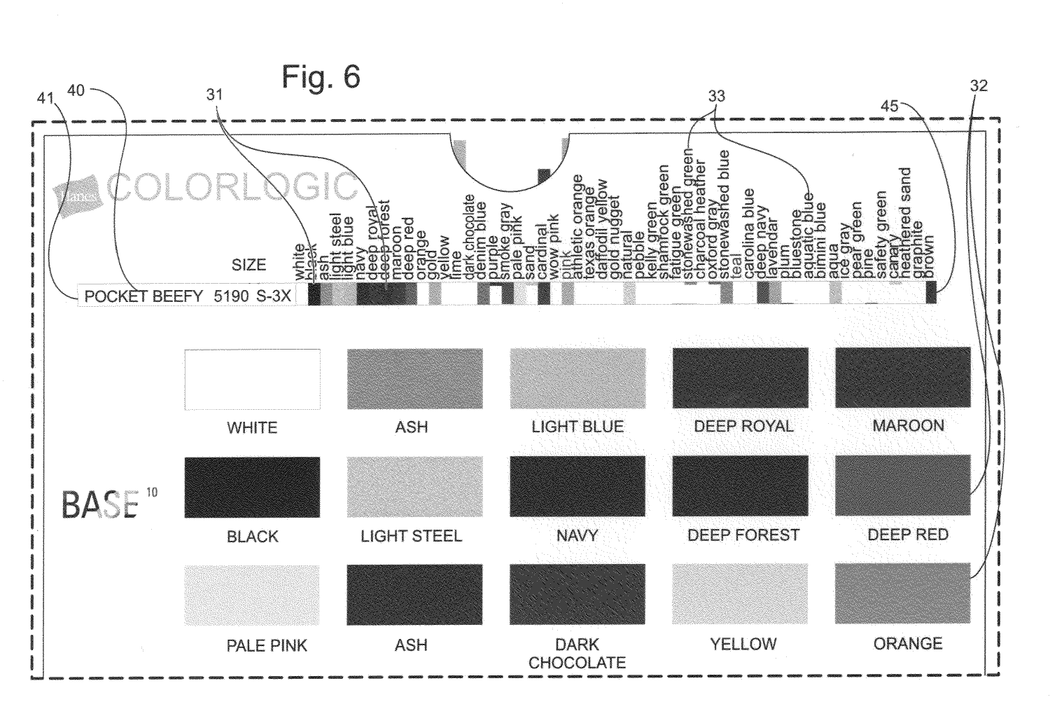

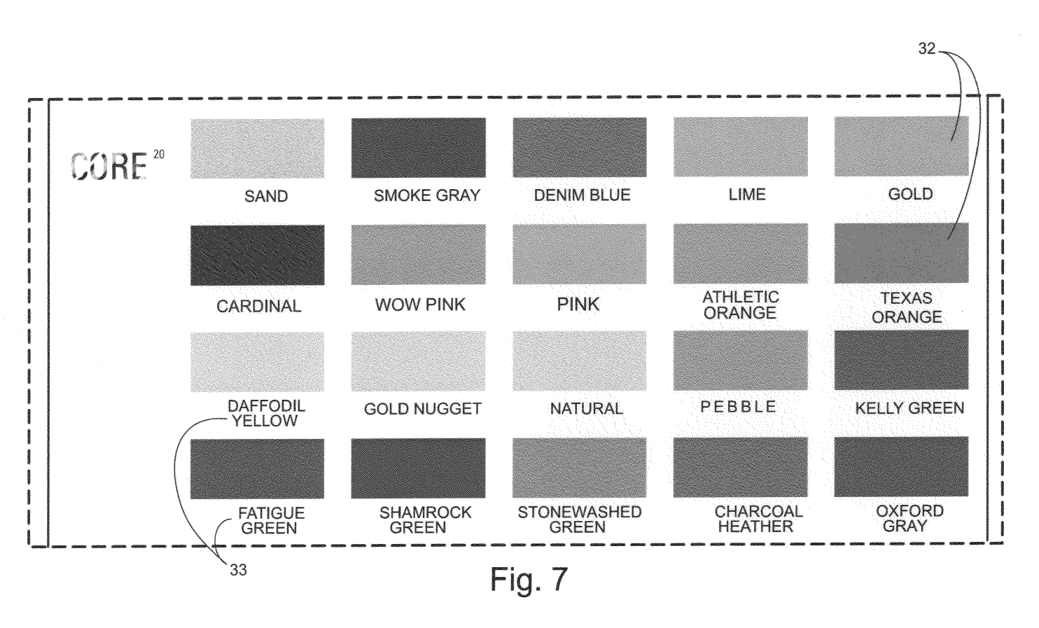

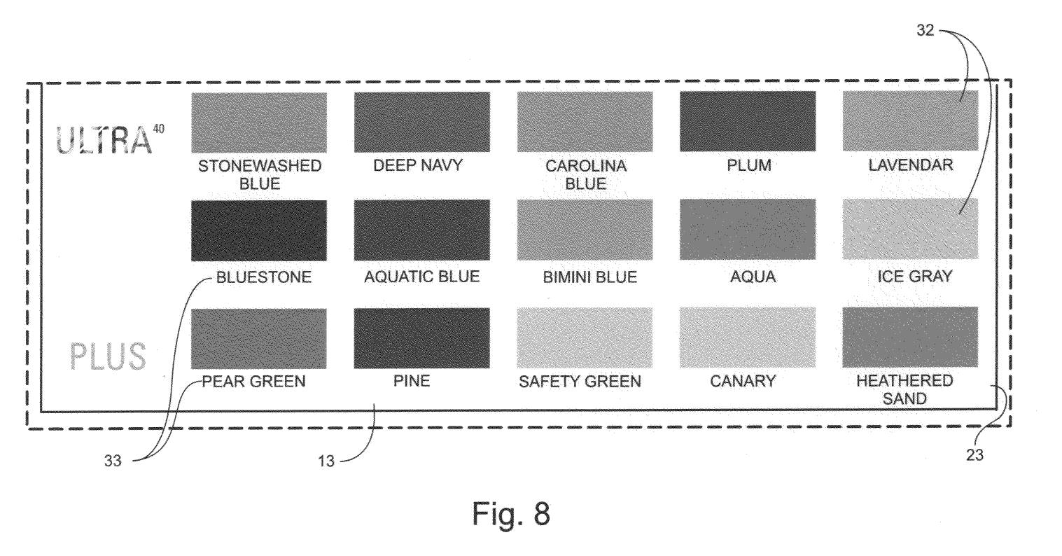

As shown in FIGS. 3 and 4, in some embodiments, the outer surface of the back side 23 of the sleeve 11 can include a display 30 of all of the product characteristics 31 related to products identified in the device 10. For example, the display 30 of all of the product characteristics 31 on the back side 23 of the sleeve 11 can include the display 30 of all the colors 32 available for the products identified on the inner card 20. In this embodiment, the display 30 includes a sample of each of the 50 colors 32 in which the identified products are potentially available and the description, or name, 33 of the color 32 adjacent the color sample. Such a display 30 of color samples provides a quick reference to all potential colors 32 for the identified products. In addition, the outer sleeve color display 30 can provide a larger sample of each of the colors 32 than the vertical columns 34 of colors 32 on the inner card 20, such that the colors 32 may be easier to visualize. In some embodiments, the description 33 of each of the product characteristics on the inner card 20 can be placed on the outer sleeve 11 adjacent a position at which each of the product characteristics 31 is displayable in the product characteristic window 45.

The outer sleeve 11 and the inner card 20 can be formed of various materials. For example, either or both of the outer sleeve 11 and the inner card 20 can comprise cardboard or other suitable sheet material. Either or both of the outer sleeve 11 and the inner card 20 may be laminated. Preferably, the outer sleeve 11 and the inner card 20 can have dimensions and comprise materials such that the inner card 20 can slide within the outer sleeve 11 and into and out of the open top 14 of the sleeve 11 without undesirable friction.

In some embodiments, the inner card 20 can include product identification information 40 arranged vertically along the y-axis 42 along one side 12 of the inner card 20. As the inner card 20 is moved upwardly out of and downwardly into the outer sleeve 11, the product identification information 40 can be displayed through a product identification window, or block 41 in the back side 23 of the outer sleeve 11. Product identification information 40 can include various types of indicia of products. For example, product identification indicia can include the category of product, name of the particular product, style number, catalog number, size, photograph, graphic representation, and/or other product indicia.

In some embodiments, the inner card 20 can include product characteristics 31 arranged horizontally in columns along the x-axis 43 across the inner card 20 to provide a matrix of product characteristics 31 available for identified products. For example, the product characteristics 31 can be the colors 32 of the products. The colors 32 can be arranged horizontally across the x-axis 43 of the inner card 20 according to various qualities, for example, from darkest to brightest and/or according to hue.

In certain embodiments, the front side of the outer sleeve 11 can include cut-outs 44 of wording or other graphics, as shown in FIG. 1. In particular embodiments, both faces (front side 22 and back side 23) of the inner card 20 can include the columns of colors 32. In such embodiments of the device 10 having product colors 32 as the product characteristic 31 and the colors 32 arranged in columns on both faces across the inner card 20, various ones of the plurality of colors 32 can show through the cut-outs 44 of wording or other graphics in the front 22 of the sleeve 11. In this way, the user is able to visualize portions of the columns of colors 32 and thereby ascertain that the device 10 may provide indication of product colors 32.

In some embodiments, the colors 32 in the greatest number of products, such as garments, identified on the inner card 20 can be placed toward the left side of the inner card 20. The colors 32 in the fewest number of garments identified on the inner card 20 can be placed toward the right side of the inner card 20. In this way, the colors 32 displayed on the inner card 20 from left to right along the horizontal axis, or x-axis 43, across the card 20 may be available in decreasing numbers of garments identified along the y-axis 42 down the side 12 of the inner card 20.

In some embodiments, the products having the greatest number of color 32 choices can be placed toward the top 14 of the inner card 20, and the products having the fewest number of color 32 choices can be placed toward the bottom 13 of the inner card 20. In this way the products listed along the vertical y-axis 42 along the left side of the card 20 can have decreasing numbers of color 32 choices from the top 14 to the bottom 13 of the card 20.

Product characteristics 31 can be arranged along the y-axis 42 on the inner card 20 in any other order useful for identifying the availability of products having particular characteristics 31. For example, various outerwear garments can be listed according to styles in the vertical column along the x-axis 43 of the inner card 20, and the sizes in which each style of outerwear garment is available can be identified on the row adjacent a particular style.

As another example, in certain embodiments, different categories of garments can be identified in the product identification window, or block 41. For example, the product identification block 41 may include categories of pants, jackets, sweaters, and blouses. Further, under each category of garments, the sizes for each type of garment can be listed. The color 32 for each size of each garment type can be identified along the x-axis 43 of the inner card 20 adjacent that particular garment. In this way, a person using such an embodiment of the product identification device 10 and system can readily identify which colors 32 are available for each type and size of garment listed. In addition, possible available color combinations of garment types—that is, pants, jackets, sweaters, and/or blouses—can be quickly determined.

Certain embodiments of the product identification device 10 can include a product characteristic window 45 in the back side 23 of the outer sleeve 11. The product characteristic window 45 can be placed along the top 14 of the back side 23 of the outer sleeve 11 along the horizontal y-axis 42. The names of each of various product characteristics, for example, the colors 32, can be displayed on the back 23 of the outer sleeve 11 adjacent the product characteristic window 45 in the location where each respective characteristic 31 on the inner card 20 would appear. For example, the product characteristic window 45 can be a product color indicator window. The names of the colors 32 that would appear in the product color window 45 from a particular vertical column on the inner card 20 inside the outer sleeve 11 can be indicated on the outer sleeve 11 adjacent the respective columns for those particular colors 32.

In certain embodiments, the inner card 20 can be moved upwardly out of the outer sleeve 11 or downwardly into the sleeve 11 so as to bring the name of a particular product and each of the colors 32 in which the product is available into registration with the product characteristic indicator window 45. For example, if product “A” is a shirt that is available in red, yellow, green, and blue, moving the inner card 20 up and down to reveal the product identification information 40 for the product “A” shirt along the left side in the product identification block 41 can simultaneously reveal vertical columns, or stripes, of the colors 32 red, yellow, green, and blue in the product characteristic indicator window 45. Each of the colors 32 red, yellow, green, and blue would appear in the product characteristic window 45 adjacent the respective name for that color 32. In this manner, a person using such an embodiment of the product identification device 10 and system can quick and easily identify in which colors 32 a particular product is available.

In certain embodiments, the product identification block 41 can be located vertically along the length of the right side of the inner card 20, rather than along the left side of the card 20 as shown in FIG. 4. In other embodiments, a second block, or column, of product characteristics 31 can be placed vertically along the right side of the card 20 in addition to the product characteristics 31 placed horizontally across the card 20. In this manner, the inner card 20 can provide a matrix identifying two different product characteristics 31 for each product identified in the product identification block 41. For example, the product characteristics 31 along the horizontal y-axis 42 at the top 14 of the inner card 20 can be product colors 32, and the product characteristic 31 along the vertical y-axis 43 along the right side of the card 20 can be product size.

In certain embodiments, the product identification device 10 can further include a locking mechanism (not shown) to lock the inner card 20 in a selected position relative to the outer sleeve 11. For example, the outer sleeve 11 may include a rotatable arm located near the top 14 of the back side 23 of the sleeve 11. The inner card 20 can have a series of holes vertically along the length of the card 20. When the inner card 20 is moved to a desired position relative to the outer sleeve 11, for example, when a particular product identification information 40 appears in the product identification block 41, the arm can be rotated and positioned within the hole nearest the top of the sleeve 11. In this way, the card 20 can be locked into position so that the product identification information 40 and the product characteristics 31 remain in view in the product identification block 41 and product characteristic window 45, respectively.

In certain embodiments the outer sleeve 11 and inner movable card 20 can be replaced with at least two concentric and overlapping discs (not shown) that can be rotated about a central pivot post attaching the discs. The product identification block 41 and product characteristic window 45 can be one or more cut-outs 44 in the uppermost disc. When the discs are rotated relative to each other, product identification information 40 and associate product characteristics 31 on the lowermost disc can be viewed through the product identification block 41 and the product characteristic window 45, respectively.

Some embodiments of a product identification device 10, system, and/or method according to the present invention can provide advantages over conventional approaches to product characteristic identification to retailers and/or consumers. For example, certain embodiments of the present invention may provide a quick, simple, and inexpensive way for retailers and/or consumers to identify a range of product characteristics 31 available for a range of products. In one embodiment, such a product identification device 10, system, and/or method can allow identification in one location of all colors 32 available in a number of garments in a line of clothing.

The present invention can include embodiments of a product identification system. Such a product identification system can include the product identification device 10 as described herein. Such a system may further include user instructions printed on the outer sleeve 11 to guide use of the product identification device 10.

The present invention can include embodiments of a product identification method. Such a product identification method can include use of the product identification device 10 and/or system as described herein.

Although described primarily with respect to garments, some embodiments of the present invention can be used for products other than garments. For example, in particular embodiments, the product identification device 10, system, and method of the present invention may be used to relate various product characteristics 31 to furniture, appliances, electronics, and/or other consumer goods. The product characteristics 31 related by embodiments of the product identification device 10, system, and/or method can be other than color 32. As an example, for a line of televisions by a particular manufacturer, different TV sizes can be listed along the y-axis 42 on the inner card 20. The x-axis 43 of the inner card 20 can include various features available in different sizes of the televisions. For example, the x-axis 43 of the inner card 20 may include picture resolution values, number and type of external connection ports, on-screen functionality, etc. Moving the inner card 20 upward and downward relative to the outer sleeve 11 can thus reveal in the product characteristic window 45 whether a particular TV size is available with each of the listed product characteristics 31.

Features of a product identification device 10, system, and/or method of the present invention may be accomplished singularly, or in combination, in one or more of the embodiments of the present invention. Although particular embodiments have been described, it should be recognized that these embodiments are merely illustrative of the principles of the present invention. Those of ordinary skill in the art will appreciate that a product identification device 10, system, and/or method of the present invention may be constructed and implemented in other ways and embodiments. Accordingly, the description herein should not be read as limiting the present invention, as other embodiments also fall within the scope of the present invention.

1. A product identification device, comprising:
an outer sleeve having two sides, a bottom, and an open top;
an inner card slidable into and out of the outer sleeve through the open top;
product identification information for a plurality of products arranged along an x-axis toward a side of the inner card;
product characteristics arranged along a y-axis of the inner card and in selective association with each of the plurality of products;
a product identification window in the outer sleeve adapted to display the product identification information for one of the plurality of products at a time; and
a product characteristic window in the outer sleeve adjacent the product identification window adapted to display the product characteristics for the product displayed in the product identification window.

2. The device of claim 1, further comprising a description of each product characteristic on the outer sleeve adjacent a position for display of the product characteristic in the product characteristic window.

3. The device of claim 1, further comprising a display of each of the product characteristics on the outer sleeve and a description of the product characteristic adjacent each product characteristic on the outer sleeve.

4. The device of claim 1, further comprising a thumb notch in the top of the outer sleeve adapted to allow grasping of the inner card for sliding the inner card through the open top.

5. The device of claim 1, further comprising a plurality of ringed tabs along at least one side of the outer sleeve adapted to attached the outer sleeve to a notebook binder.

6. The device of claim 1, further comprising at least one cut-out in a surface of the outer sleeve opposite the product characteristic window, wherein the product characteristics on the inner card can be at least partially visualized through the cut-outs.

7. The device of claim 1, wherein the product characteristics comprise product colors.

8. A product identification system, comprising:
an outer sleeve having two sides, a bottom, and an open top;
an inner card slidable into and out of the outer sleeve through the open top;
product identification information for a plurality of products arranged along an x-axis toward a side of the inner card;
product characteristics arranged along a y-axis of the inner card and in selective association with each of the plurality of products;
a product identification window in the outer sleeve adapted to display the product identification information for one of the plurality of products at a time;
a product characteristic window in the outer sleeve adjacent the product identification window adapted to display the product characteristics for the product displayed in the product identification window; and
a description of each product characteristic on the outer sleeve adjacent a position for display of the product characteristic in the product characteristic window.

9. A product identification method, comprising:
providing a product identification device comprising an outer sleeve having two sides, a bottom, and an open top, and an inner card slidable into and out of the outer sleeve through the open top;
arranging product identification information for a plurality of products along an x-axis toward a side of the inner card;
arranging product characteristics along a y-axis of the inner card and in selective association with each of the plurality of products;
displaying the product identification information for one of the plurality of products at a time through a product identification window in the outer sleeve; and
displaying the product characteristics for the product displayed in the product identification window through a product characteristic window disposed in the outer sleeve adjacent the product identification window.
